(19) United States
(12) Patent Application Publication
(10) Pub. No.: US 2012/0126566 A1
(43) Pub. Date: May 24, 2012

(54) METHODS FOR IMPROVING BOND BETWEEN POLYMERIC WINDSHIELD GASKET AND ADHESIVE

(75) Inventors: George G. Jones, Lake Oswego, OR (US); Alan E. Prentice, Aloha, OR (US)

(73) Assignee: Daimler Trucks North America LLC

(21) Appl. No.: 13/176,444

(22) Filed: Jul. 5, 2011

Related U.S. Application Data
(60) Provisional application No. 61/416,596, filed on Nov. 23, 2010.

(51) Int. Cl. B60J 10/02; B60J 1/02

(52) U.S. Cl. 296/90; 156/108

(57) ABSTRACT

Disclosed herein are embodiments of a windshield assembly and methods for mounting a windshield to a vehicle frame. An exemplary method for mounting a windshield to a vehicle frame comprise treating a surface of a polymeric gasket with fluoro-oxidation, positioning the gasket on the windshield, treating the surface of the gasket with a liquid composition comprising one or more reactive adhesion promoters, applying a polyurethane-based adhesive to the treated surface of the gasket; and positioning the windshield and gasket against a mounting surface of the vehicle frame such that the adhesive adheres the treated surface of the gasket to the mounting surface.

### CROSS REFERENCE TO RELATED APPLICATION

This application claims the benefit of U.S. Provisional Application No. 61/416,596, filed Nov. 23, 2010.

### FIELD

This disclosure relates to methods for improving adhesive bonding to polymeric materials, and particularly to methods comprising fluoro-oxidation of the material prior to adhesive bonding.

### BACKGROUND

U.S. Pat. No. 5,073,175 discloses fluoro-oxidized polymeric membranes for gas separation and a process for preparing them. U.S. Pat. No. 6,441,128 discloses ethylene chlorotrifluoroethylene (ECTFE) surfaces modified by fluoro-oxidation and a process therefor. U.S. Publication No. 2005/0005990 discloses a method for making tubular articles having a fluoro-polymer film adhered to a metal substrate. U.S. Publication No. 2005/0191435 discloses a method for improving barrier properties of plastic containers by subjecting the containers to a reactive gas atmosphere in order to improve adhesion of coatings. U.S. Publication No. 2009/0130314 discloses a system for adhesion treatment, coating and curing of wood polymer composites.

### SUMMARY

Disclosed herein are embodiments of a windshield assembly and methods for mounting a windshield to a vehicle frame.

In some exemplary embodiments, a windshield assembly for a land vehicle comprises a windshield window frame, a windshield having a periphery, a gasket comprising a polymeric material and sized to engage the periphery of the windshield, the gasket having a fluoro-oxidized outer surface to which a primer may be applied, and an adhesive positioned to hold the outer surface of the gasket to the windshield window frame.

In some embodiments of the windshield assembly, the gasket comprises rubber. In some embodiments, the adhesive is polyurethane-based. In some embodiments, the primer comprises a liquid composition comprising one or more adhesion promoters.

In some windshield assembly embodiments, the gasket comprises EPDM rubber, the primer comprises a liquid composition comprising one or more adhesion promoters and/or groups facilitated by adhesion promoters and/or chemical coupling agents that may include reactive silane, the primer further comprises one or more alcohols and/or one or more aliphatic compounds, the adhesive is polyurethane based and comprises at least one urethane prepolymer based on at least one or more polyols and at least one isocyanates, polyisocyanates, polyetherpolyols and/or polyesterpolyols. The polyurethane prepolymer can comprise MDI methylene bisphenyl isocyanate and/or a polyether polyol.

Further embodiments of the windshield assembly comprise a windshield window frame, a windshield having a periphery, a gasket comprising a polymeric material and sized to engage the periphery of the windshield, the gasket having a fluoro-oxidized outer surface, and an adhesive positioned to hold the outer surface of the gasket to the windshield window frame.

Some exemplary methods for mounting a windshield to a vehicle frame comprise treating a surface of a polymeric gasket with fluoro-oxidation, positioning the gasket on the windshield, treating the surface of the gasket with a liquid composition comprising one or more polymeric adhesion promoters, applying a polyurethane-based adhesive to the treated surface of the gasket; and positioning the windshield and gasket against a mounting surface of the vehicle frame such that the adhesive adheres the treated surface of the gasket to the mounting surface. Further embodiments of a method for mounting a windshield to a vehicle frame comprise treating a surface of a polymeric gasket with fluoro-oxidation, positioning the gasket on the windshield, applying a polyurethane-based adhesive to the treated surface of the gasket, and positioning the windshield and gasket against a mounting surface of the vehicle frame such that the adhesive adheres the treated surface of the gasket to the mounting surface. In some of these methods, the polymeric gasket comprises EPDM rubber.

The foregoing and other objects, features, and advantages of the invention will become more apparent from the following detailed description, which proceeds with reference to the accompanying figures.

### BRIEF DESCRIPTION OF THE DRAWINGS

FIG. 1 is a perspective view of an exemplary vehicle cab having a frame and a windshield.

FIG. 2 is an enlarged view of a portion of FIG. 1 showing an upper and a lower interface between the windshield and the frame.

### DETAILED DESCRIPTION

The inventive features and method acts include all novel and non-obvious features and method acts disclosed herein both alone and in novel and non-obvious sub-combinations with other elements and method acts. Unless specifically stated otherwise, processes and method acts described herein can be performed in any order and in any combination, including with other processes and/or method acts not specifically described. In this disclosure, it is to be understood that the terms “a”, “an” and “at least one” encompass one or more of the specified elements. That is, if two of a particular element are present, one of these elements is also present and thus “an” element is present. The phrase “and/or” means “and”, “or” and both “and” and “or”. Further, the term “coupled” generally means electrically, electromagnetically, and/or physically (e.g., mechanically or chemically) coupled or linked and does not exclude the presence of intermediate elements between the coupled or associated items absent specific contrary language.

Described herein are methods for improving adhesive bonding to polymeric materials. Exemplary methods described herein can include fluoro-oxidation of polymeric material and subsequent chemical treatment of the material surface prior to adhesive bonding.

Exemplary methods can comprise treating a surface of a polymeric material with fluoro-oxidation, subsequently treating the surface with a liquid composition comprising one or more reactive adhesion promoters, and subsequently applying a polyurethane-based adhesive to the treated surface. In some of these methods, the liquid composition can include a silane. The liquid composition can further comprise one or more alcohols and/or one or more aliphatic compounds. An exemplary adhesion promoter is a compound that includes a silane.

In some methods, the polymeric material can comprise ethylene propylene diene monomer (EPDM) rubber. The urethane prepolymer can comprise one or more polyisocyanates, one or more polyetherpolyols and/or one or more polyesterpolyols.

In some methods, an exemplary average bond strength between the treated surface of the polymeric material and the adhesive can be about 79 lb/in. In some of these methods, the primary failure mode can be cohesive failure.

An exemplary application of these methods can be for improving the adhesive bond strength of a rubber windshield gasket. While this exemplary application and similar applications are described in detail hereinafter, it should be noted that the features and method acts described herein with reference to rubber windshields gasket applications can be similarly applied to other applications where improved adhesive bonds of polymeric materials are desirable.

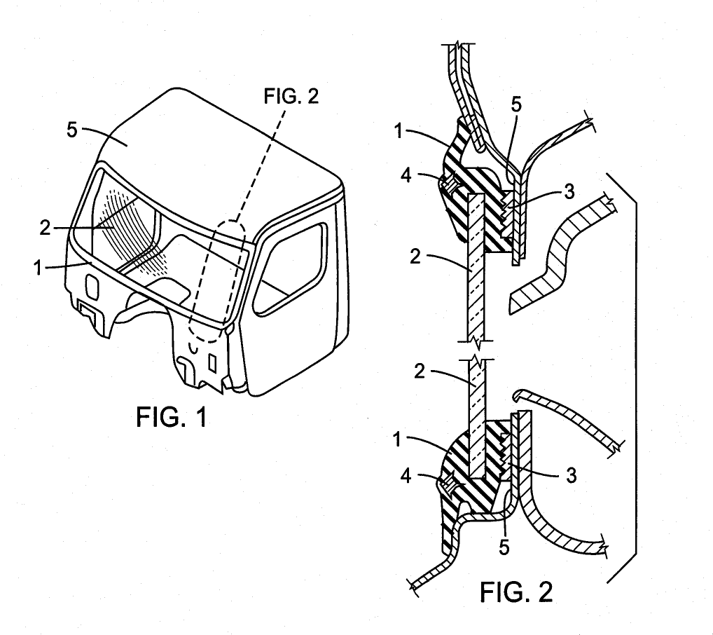

Various techniques can be used to mount a windshield to a vehicle frame. FIGS. 1 and 2 show an exemplary windshield 2 mounted to the frame 5 of a vehicle. Some of these techniques include using a gasket to couple the windshield to the frame. For example, a gasket 1 can be fitted around the edges of a glass windshield 2, such that the glass is surrounded and physically held in place, or encapsulated, by the gasket. An encapsulated windshield 2 can be mounted to a metal frame 5 of the vehicle with an adhesive material 3. One surface of the adhesive 3 can be adhered to the gasket 1 while another surface of the adhesive can be adhered to the metal frame 5. The gasket-to-adhesive bond can be improved, for example, by pretreating the bonding surface of the gasket 1 to change the surface properties of the gasket and thereby enable stronger chemical bonding with the adhesive 3. Superior bond strengths can reduce adhesive failures and reduce windshield leaks.

Adhesives used to couple a windshield gasket to a vehicle frame can comprise an adhesive material suitable for bonding to both the gasket material and the vehicle frame material. The adhesive 3 can comprise a thermoset polymer, such as polyurethane, and can be hot-applied and moisture-cured. The polyurethane adhesive can comprise at least one urethane prepolymer which can be based on at least one polyol. In some embodiments, the urethane prepolymer can be formed from one or more polyisocyanates, one or more polyetherpolyols and/or one or more polyesterpolyols. In some of these embodiments, the prepolymer can have a free isocyanate content of from about 0.6 to about 3.5% by weight, based on the weight of the polyurethane. In some embodiments, the adhesive can comprise an isocyanate-functional polyurethane prepolymer and a combination of several catalysts. In windshield replacement applications, exemplary polyurethane adhesives can allow for a sufficient working time and development of green strength to provide a safe drive-away time within 1 hour at a temperature from about 0° C. to about 100° C.

For example, the adhesive 3 can be SikaTack® Ultrafast (“Ultrafast”) or SikaTack® ASAP (“ASAP”), which are commercially available polyurethane-based adhesives from Sika Corporation. More information regarding exemplary polyurethane adhesives can be found in U.S. Pat. Nos. 4,374,237, 4,687,533, 5,922,809, 5,936,018, 6,133,395, 6,133,398, 7,226,523 and 7,741,425.

The gasket 1 can comprise one or more polymeric materials, such as an elastomeric material that provides a durable, flexible and waterproof coupling between the glass windshield and the metal frame of the vehicle. One exemplary gasket material is synthetic rubber, such as ethylene propylene diene monomer (EPDM) rubber. In some cases, the gasket can comprise non-polar EPDM rubber. The gasket material can also comprise other elastomers such as polyisoprene, polybutadiene, polychloroprene, butyl rubber, styrene-butydine rubber, nitrile rubber, EPM rubber, fluoroelastomer, and/or a thermoplastic vulcanizate.

To improve the bond between the adhesive 3 and the gasket 1, it can be desirable to increase the wettability of the adhesive on the surface of the gasket. Treating the polymer chains at the surface of the gasket to make them more polarized can increase the surface energy of the gasket surface and can increase the wettability of the adhesive on the gasket surface, thereby improving the bond strength between the gasket and the adhesive.

The gasket 1 can be treated with fluoro-oxidation to modify the surface properties of the gasket. Fluoro-oxidation can make the polymer chains at the surface of the gasket more polarized and create more reactive bond sites at the surface of the gasket. An exemplary fluoro-oxidation process can include placing the gasket in a sealed chamber, creating an at least partial vacuum, and adding F₂, O₂, and one or more inert carrier gasses, such as N₂, to the chamber to treat the gasket at high pressure and high temperature. The ratio of F₂ can be kept low relative to O₂ to avoid fluorination and increase oxidation at the surface of the gasket. The gasket may need to be cleaned of particulates prior to the fluoro-oxidation process to avoid ignition and burning of the gasket material. The resulting surface of the gasket can be highly polar, thus providing improved adhesive wetting. The surface tension of a non-polar EPDM rubber gasket treated with fluoro-oxidation can be about 36 Dynes/cm, while the surface tension of a non-polar EPDM rubber gasket not treated with fluoro-oxidation can be about 20-30 Dynes/cm. Additional information regarding fluoro-oxidation can be found in U.S. Pat. No. 6,441,128, which is incorporated herein by reference.

After the gasket 1 is treated with fluoro-oxidation, the gasket can be fitted around the windshield glass 2. The gasket can surround the edges of the glass to encapsulate and/or physically hold the glass in place. In such cases, the gasket 1 can comprise an inner groove for receiving the edges of the glass 2, as shown in FIG. 2. The gasket can also be adhesively bonded to the glass.

After the gasket 1 is treated with fluoro-oxidation, but before the adhesive 3 is applied to the gasket, the surface of the gasket can be treated with at least one primer to further improve the adhesion of the adhesive to the gasket. An exemplary primer can be a liquid composition comprising one or more prepolymers based on a polyol provided with reactive terminal groups, whereby said polyol contains or consists of a hydrogenated polyisoprene-diol. Exemplary reactive terminal groups can include isocyanate groups or silane groups. Primers can also comprise one or more alcohols, one or more aliphatic compounds and/or other ingredients. Illustrative alcohols can comprise lower alkyl (e.g., 1-6 carbon atoms) alcohols such as ethanol, methanol and isopropanol. Illustrative aliphatics include lower alkanes (e.g., 1-10 carbon atoms) such as hexane and heptane. Exemplary primers include Sika® Aktivator (“Aktivator”) and Sika® Aktivator Pro, commercially available from Sika Corporation. More information regarding exemplary primers can be found in U.S. Pat. Nos. 6,602,947, 7,507,443 and 7,683,196.

The primer can be applied to the surface of the gasket in any suitable way, such as by wiping a lint-free pad moistened with the primer along the surface of the gasket and then wiping the agent off with a clean, dry cloth or paper towel. In addition to chemically reacting with the gasket material, the agent can also clean the surface of the gasket. After applying the primer to the gasket, the agent can be allowed to dry for a certain period of time, such as from about 10 minutes to about two hours, before applying adhesive to the surface of the gasket, depending on environmental conditions, such as temperature and humidity. Aktivator, for example, can have a flash off time of about three minutes at 15° F. to 120° F. and a flash off time of about 10 minutes at 0° F. to 15° F. The primer can be applied to the gasket before the gasket is fitted around the windshield glass, but is preferably applied afterward.

The mounting surface 5 of the vehicle frame can also be pretreated to improve adhesive bond strength. The surface of the frame can be bare metal, such as steel or aluminum, or the surface can include paint, rust, dirt, oil and/or other materials. The frame surface can be mechanically and/or chemically cleaned to remove at least some of this material. For example, a primer can be applied to the frame surface to remove unwanted material, touch up scratches, prevent further corrosion and/or provide UV protection. An exemplary primer is Sika® Primer 206 G+P, which is commercially available from Sika Corporation. The mounting surface can also be treated with a primer such as Aktivator to further improve the bond strength between the frame and the adhesive. For example, the mounting surface of the frame can first be mechanically cleaned to remove paint, rust, oil and dirt, then the mounting surface can be treated with a primer such as Primer 206 G+P, and then the mounting surface can be treated with a primer such as Aktivator.

Once the gasket 1 and the mounting surface 5 are prepared, the adhesive material 3 can be applied to the gasket surface, the mounting surface of the frame, or both. In some cases, the adhesive can be prepared by adjusting the temperature of the adhesive prior to application. For example, the adhesive can be warmed in an oven to a desired application temperature.

After the adhesive 3 is applied, the windshield 2 encapsulated by the gasket 1 can be mounted to the frame 5, as shown in FIGS. 1 and 2, by positioning the gasket against the mounting surface of the frame and allowing the adhesive 3 sufficient time to bond to both surfaces. Lock strips 4 can be applied to increase the pressure between the gasket 1 and both the glass 2 and the mounting surface 5.

Other methods of pretreating the gasket 1 can include mechanically abrading the gasket bonding surface and/or applying a solvent-based surface treatment such as Chemlock® 7701 from Lord Corporation (“Chemlock”).

Treating the gasket 1 with both fluoro-oxidation and/or a primer such as Aktivator prior to applying the adhesive 3 to the gasket can significantly improve the bond between the adhesive and the gasket. Desirably, the adhesive strength between the gasket and the adhesive is greater than the cohesive strength of the adhesive, such that failure occurs within the adhesive (“cohesive failure”) rather that at the interface of the gasket and the adhesive (“adhesive failure”). In some cases, cohesive failure can occur nearer to, but not at, one of the gasket surfaces, which can be referred as thin line cohesive failure (“TLC failure”), such that more adhesive is present on one layer of gasket material relative to the other layer. TLC failure can be evidence of an inferior bond between the gasket and the adhesive compared to normal cohesive failure where about equal amounts of adhesive are left on both layers of gasket material. Most preferably, however, is when the entire adhesive bond is stronger than the gasket material, in which case tearing or rupture occurs within the gasket material (“substrate failure”).

The bond strength between the gasket 1 and the adhesive 3 can be measured, for example, using a T-Peel test wherein two layers of gasket material bonded together with an adhesive and peeled apart. The force required to peel apart the two layers is measured and divided by the transverse width of the bond, resulting in a bond strength measurement having units of lb/in.

With reference to Table 1 below, an exemplary average bond strength with a non-polar EPDM gasket mechanically abraded and treated with Chemlock and Aktivator, but not treated with fluoro-oxidation, can be about 16 lb/in, with the primary failure mode being TLC failure. An exemplary average bond strength with the non-polar EPDM gasket treated with fluoro-oxidation but not mechanically abraded and not treated with Chemlock or Aktivator can be about 27 lb/in, with the primary failure mode being TLC failure. With further reference to Table 1, an exemplary average bond strength between the gasket and adhesive with the gasket treated with both fluoro-oxidation and Aktivator but not mechanically abraded and not treated with Chemlock can be about 79 lb/in, with the primary failure mode being cohesive failure. Thus, the combination of fluoro-oxidation and Aktivator treatment can improve the bond strength between the non-polar EPDM rubber gasket and the Ultrafast adhesive by more than 600% compared to pretreating with mechanical abrasion, Chemlock and Aktivator but not fluoro-oxidation.

TABLE 1

| Test | Material | Adhesive | F-O? | Aktiv? | lb/in | Failure Mode |
|---|---|---|---|---|---|---|
| 1 | NP EPDM | Ultrafast | Y | Y | 62.00 | 70% C |
| 2 | NP EPDM | Ultrafast | Y | Y | 96.60 | C |
| 3 | NP EPDM | Ultrafast | Y | Y | 68.97 | C |
| 4 | NP EPDM | Ultrafast | Y | Y | 75.71 | 70% C |
| 5 | NP EPDM | Ultrafast | Y | Y | 97.48 | C |
| 6 | NP EPDM | Ultrafast | Y | Y | 77.33 | C |
| 7 | NP EPDM | Ultrafast | Y | Y | 79.92 | C |
| 8 | NP EPDM | Ultrafast | Y | Y | 92.38 | C |
| 9 | NP EPDM | Ultrafast | Y | Y | 69.28 | 80% C |
| 10 | NP EPDM | Ultrafast | Y | Y | 74.21 | 85% C |
| | | Average | | | 78.62 | |
| | | Stdev | | | 8.65 | |
| 11 | NP EPDM | Ultrafast | Y | N | 24.49 | TLC |
| 12 | NP EPDM | Ultrafast | Y | N | 25.25 | TLC |
| 13 | NP EPDM | Ultrafast | Y | N | 29.88 | TLC |
| 14 | NP EPDM | Ultrafast | Y | N | 25.51 | TLC |
| 15 | NP EPDM | Ultrafast | Y | N | 28.14 | TLC |
| | | Average | | | 26.66 | |
| | | Stdev | | | 2.27 | |
| 16 | NP EPDM | Ultrafast | N | Y* | 11.73 | TLC |
| 17 | NP EPDM | Ultrafast | N | Y* | 17.78 | TLC |
| 18 | NP EPDM | Ultrafast | N | Y* | 23.16 | TLC |
| 19 | NP EPDM | Ultrafast | N | Y* | 14.91 | TLC |
| 20 | NP EPDM | Ultrafast | N | Y* | 13.52 | TLC |
| | | Average | | | 16.22 | |
| | | Stdev | | | 4.00 | |

*Abraded w/Chemlock and Activator

In view of the many possible embodiments to which the principles of the disclosed invention may be applied, it should be recognized that the illustrated embodiments are only preferred examples of the invention and should not be taken as limiting the scope of the invention. Rather, the scope of the invention is defined by the following claims. We therefore claim as our invention all that comes within the scope and spirit of these claims.

We claim:

1. A windshield assembly for a land vehicle, comprising:
a windshield window frame;
a windshield having a periphery;
a gasket comprising a polymeric material and sized to engage the periphery of the windshield, the gasket having a fluoro-oxidized outer surface to which a primer is applied; and
an adhesive positioned to hold the outer surface of the gasket to the windshield window frame.

2. The windshield assembly of claim 1, wherein the gasket comprises rubber.

3. The windshield assembly of claim 1, wherein the adhesive is polyurethane-based.

4. The windshield assembly of claim 1, wherein the primer includes a silane.

5. The windshield assembly of claim 1 wherein the primer comprises a liquid composition comprising one or more adhesion promoters.

6. The windshield assembly of claim 1, wherein:
the gasket comprises EPDM rubber;
the primer comprises a liquid composition comprising one or more alcohols and one or more aliphatic compounds; and
the adhesive is polyurethane based and comprises at least one urethane prepolymer, the at least one urethane prepolymer comprising one or more polyisocyanates, one or more polyetherpolyols or one or more polyesterpolyols.

7. The windshield assembly of claim 6, wherein the at least one urethane prepolymer comprises one or more polyisocyanates.

8. The windshield assembly of claim 6, wherein the at least one urethane prepolymer comprises one or more polyetherpolyols.

9. The windshield assembly of claim 6, wherein the at least one urethane prepolymer comprises one or more polyesterpolyols.

10. The windshield assembly of claim 1, wherein the adhesive comprises a polyurethane that includes a polyisocyanate, and the primer comprises one or more alcohols and one or more aliphatic compounds.

11. The windshield assembly of claim 1, wherein the primer comprises one or more adhesion promoters.

12. A windshield assembly for a land vehicle, comprising:
a windshield window frame;
a windshield having a periphery;
a gasket comprising a polymeric material and sized to engage the periphery of the windshield, the gasket having a fluoro-oxidized outer surface; and
an adhesive positioned to hold the outer surface of the gasket to the windshield window frame.

13. A method for mounting a windshield to a vehicle frame, the method comprising:
treating a surface of a polymeric gasket with fluoro-oxidation;
positioning the gasket on the windshield;
applying a polyurethane-based adhesive to the treated surface of the gasket; and
positioning the windshield and gasket against a mounting surface of the vehicle frame such that the adhesive adheres the treated surface of the gasket to the mounting surface.

14. The method of claim 13, further comprising treating the gasket surface with a primer composition.

15. The method of claim 13, wherein the adhesive is polyurethane-based.

16. The method of claim 14, wherein the primer includes a silane.

17. The method of claim 14, wherein the primer comprises a liquid composition comprising one or more adhesion promoters.

18. The method of claim 13, wherein the polymeric gasket comprises EPDM rubber.

19. The method of claim 14, wherein:
the primer comprises a liquid composition comprising one or more alcohols and one or more aliphatic compounds; and
the adhesive is polyurethane based and comprises at least one urethane prepolymer, the at least one urethane prepolymer comprising one or more polyisocyanates, one or more polyetherpolyols or one or more polyesterpolyols.
